(19) United States
(12) Patent Application Publication
(10) Pub. No.: US 2012/0050022 A1
(43) Pub. Date: Mar. 1, 2012

(54) Safety Warning Device Using a Visual Tape and Motion Sensor Component

(76) Inventor: Rodney Lynn Leisure, Prosper, TX (US)

(21) Appl. No.: 12/868,680

(22) Filed: Aug. 25, 2010

(51) Int. Cl. G08B 21/00

(52) U.S. Cl. 340/431

(57) ABSTRACT

A Safety Warning Device which when the visual tape and motion sensor mechanisms are components of vertical posts (both primary and corresponding), can be mounted to a base (permanent or portable) or customized to fit on a flatbed trailer, which when the visual tape is extended and the motion sensor mechanism is activated provides both an audible and visual warning, notifying person(s) when they are in danger or in a restricted/unauthorized area. The tape is a visual warning which is high enough to be seen by person(s). The height can be adjusted on both the primary and corresponding posts. The motion sensor is an audible warning when the motion sensor beam is disturbed or interrupted. This can be an immediate warning as well as a signal sent to an alternative warning mechanism.

### FEDERALLY SPONSORED RESEARCH

None

### SEQUENCE LISTING

None

### BACKGROUND

Shipping personnel have refused to work on the bed of flatbed trailers or drive forklifts (i.e. loading/unloading devices) on regular flatbed trailers due to the fear of falling over the edge or end of this type of trailer.

Some flatbed trailers are equipped with removable walls or “side kits”. These are specialized trailers and are not common place with contracting flatbed services.

These side kits are owned by the trucking company and considered part of the trailer. Typically they are bulky, heavy and not easily assembled or removed. Their primary use is protection of the cargo during transit. Other then the walled site line of side kits, they provide limited visual and no audible warning to the cargo loader of his proximity to the edge or end of the trailer.

Because there are differences in the style of regular flatbed trailers, a need also exists for a safety warning device to be convertible, able to conform to the different flatbed trailer types and used universally.

An audible and visual safety warning device would benefit both the trucking company and the shipping or receiving company. Making this safety warning device storable will enable it to be owned and transported by the truck operator and/or shipping personnel at the site of loading or unloading.

Many times cargo loading areas are staffed with only a few employees or direct supervision is limited during the loading or unloading process. A need exists to audibly alert both the employee loading cargo onto or off a trailer, any personnel near this impending danger and any off site personnel who can assist or prevent injury when notified.

These safety concerns also apply in areas other then the loading or unloading of cargo on regular flatbed trailers. As an example construction areas and machine shops have also looked for ways to warn employees or visitors of danger.

A similar need is seen in alerting personnel or warning individuals of impending danger with both audible and visual means. Currently there is not a portable device that provides a person or persons a warning of danger both visually and audibly, which can be configured to the specific area being protected.

Based on the problems set forth above a need exists for both a visual warning and audible warning signal, with the ability to easily install, remove and store this device and for the ability to notify off site personnel of another persons danger or intrusion.

This device can be customized for use with flatbed trailers being portable and storable or mounted to a stand and used as a general purpose safety warning device. It may be portable, or permanently secured to provide a stationary warning device.

### SUMMARY

A Safety Warning Device promoting safe loading/unloading of regular flatbed trailers, using both a visual and audible warning mechanism and is removable, convertible and easily stored. The safety device includes posts which rest on the floor of a regular flatbed trailer and lock into the side railing to stabilize and hold the post in place with the use of an adjustable tension pad and visual tape that provides a site line for loading personnel to view where the end or edge of the trailer is, even while on a forklift or loading machine. A motion sensor provides an audible alert when the sensor beam is interrupted or disturbed. The alert gives an immediate warning that the loading instrument or person is dangerously close to the edge of the trailer. An additional alternative warning mechanism can be used to alert off site personnel when the sensor beam is interrupted.

One aspect of this invention is to provide an easy and temporary means to safely load regular flatbed trailers, which do not already have side kits or other permanent/semi-permanent sidings. This safety device is meant to be removed and used on different styles of regular flatbed trailers as it is convertible. It can be provided by the shipper, receiver or transportation company, as it is easily storable.

This Safety Warning Device, designed for use on a regular flatbed can provide two means of warnings to loading/unloading personnel:

1. A visual tape or strip extended from the top of the device extends from the end of a trailer to the front or opposite end of the trailer (when positioned at the furthest front and rear of trailer). The height can be adjusted to allow visibility by a person on a forklift, allowing a clear site line identifying the edge of the trailer.

2. A motion sensor whose sensor beam provides a means to detect motion near a dangerous or prohibited area. If a worker or loading/unloading machinery approaches the edge of the trailer, interrupting the sensor beam, an audible warning signal will sound. This immediately alerts the worker to redirect his person or device preventing him from falling over the edge or end of a trailer.

The motion sensor can also provide a notification to personnel not located at the loading location by means of a separate alternative warning mechanism giving a visual and/or audible warning when the sensor beam has been disturbed or interrupted. This gives a warning that assistance is needed or that further supervision is required.

The Safety Warning Device can be removed, allowing the trailer to proceed to its destination. This device can then be used at the delivery point in the same manner (if provided by the trucking company or also owned by the receiving company). If owned by the shipping location, it can be used for loading the next regular flatbed trailer.

A Safety Warning Device using straight vertical posts, when mounted in a base or platform will provide immediate warning to someone or something of danger or of an unauthorized area. The Safety Warning Device includes, visual tape that provides a site line, a motion sensor with a sensor beam providing an audible alert when the sensor beam is interrupted or disturbed. The alert gives an immediate warning that an instrument or person is dangerously close to an unauthorized area. An additional alternative warning mechanism can be used to alert off site personnel when the sensor beam is interrupted.

This Safety Warning Device can provide two means of warnings to loading/unloading personnel:

1. A visual tape or strip provides a site line alerting someone of a dangerous or unauthorized area.

2. A sensor beam with benefits of an audible warning when the sensor beam is interrupted immediately alerts the person of potential danger. This warning can also be transmitted to an alternative warning mechanism, alerting personnel (by sound and/or warning light) not in the immediate area when this sensor beam is interrupted.

Still further benefits will become apparent from a study of the following description and accompanied drawings.

### DRAWINGS

FIG. 1 is a panoramic side view of a regular flatbed trailer with the Safety Warning Device, both primary and corresponding posts, installed and fully operational in accordance with aspects of the present invention.

FIG. 2 is a perspective view of a Safety Warning Device (primary post) installed and operational, on the right rear side of a regular flatbed trailer in accordance with aspects of the present invention

FIG. 3 is an overhead view of the Safety Warning Device (primary post) installed and operational, on the right rear side of a regular flatbed trailer in accordance with aspects of the present invention.

FIG. 4 is the side view (facing) of the Safety Warning Device (primary post) in accordance with aspects of the present invention.

FIG. 5 is the side view (facing) of the Safety Warning Device (corresponding post) in accordance with aspects of the present invention.

FIG. 6 is the front view of the Safety Warning Device (primary post) in accordance with aspects of the present invention.

FIG. 7 is a view of an alternative use of the Safety Warning Device using straight vertical posts mounted on a base or stand. Also shown is an example of the alternative warning mechanism that may not be located in the immediate area of the Safety Warning Device.

### DETAILED DESCRIPTION

The Safety Warning Device includes the following primary components: Primary Post (11) to house the unit, Extending Leg (12) to allow holding the unit in the trailer railing or pocket, Pad (13) and Adjustable Mechanism for the Pad (14) to secure the post firmly on the trailer, Corresponding Post (16) which serves as a connector securing the visual tape, Extended Arm (31) to house the motion sensor, Motion Sensor Source (32) which is the source of the sensor beam warning device, Depiction of Sensor Beam (34) illustrating the sensor beam in action, Tape Housing (51) holding the visual tape in the primary post, Extendable Visual Tape (52) serves as a visual guide extending from the primary post to the corresponding post, Connector Hook (53) used to secure the tape to the Connector Housing (54) which is contained in the Corresponding Post, Alternative Warning Mechanism (61) which notifies a person not in the immediate area if the sensor beam is interrupted by a Visual Light (62) and/or Audible Alert Mechanism (63), Primary Vertical Post (71) which can house the visual tape and motion sensor device components, Corresponding Vertical Post (73) which serves as a connector securing the visual tape, Mounting Base (72) used to hold the vertical post for applications other then on a flatbed trailer, a Height Adjusting Mechanism (81) option on all posts, with a Locking Pin (83) inserted into the Locking Pin Hole (82) holding it in place.

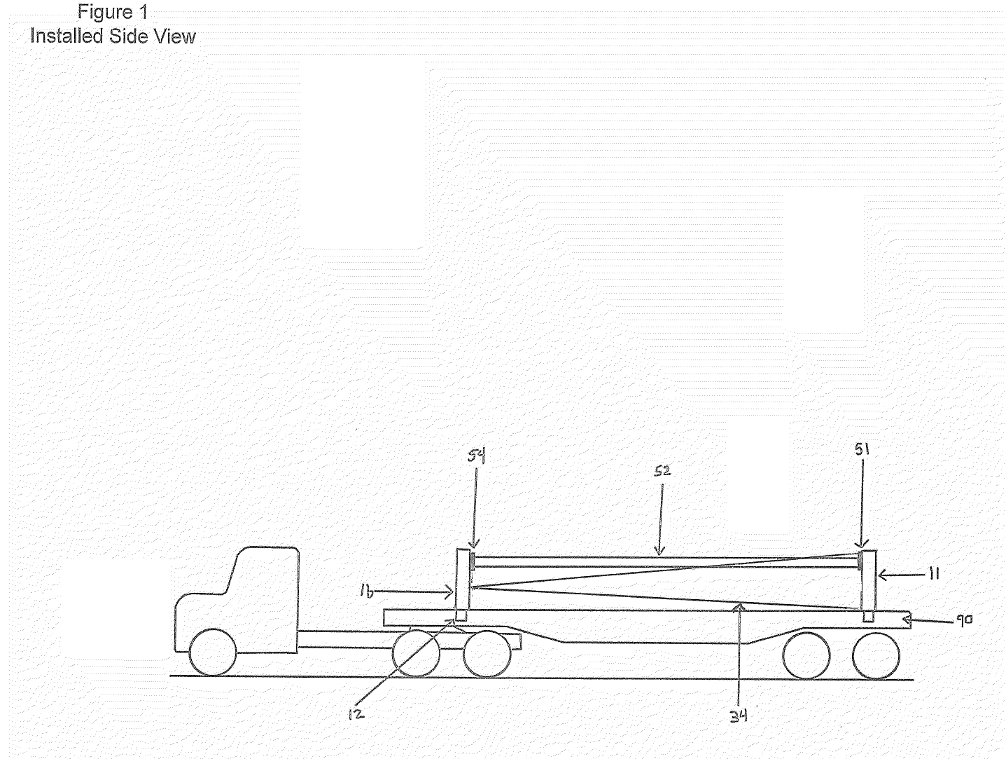

FIG. 1 Illustrates a Safety Warning Device in accordance with the present. A perspective (panoramic) view of the product in use is shown. The primary post (11) and corresponding post (16) are resting on the trailer (90) and resting in the side railing (91) or trailer pockets (92). The extended leg (12) is seen, however the pad (13) and adjustable mechanism for the pad (14), which secure the post, are not visible from this long range depiction. The visual tape (52) is shown extended and hooked to the corresponding post (16), there are limited views of the tape housing (51) and the connector housing (54). The connector hook (53) is not viewable because it is engaged in the connector housing. The sensor beam (34) is activated and illustrated, from this view the extended arm (31) and the motion sensor mechanism (32) (on the primary post), not shown is the alternative warning mechanism (61).

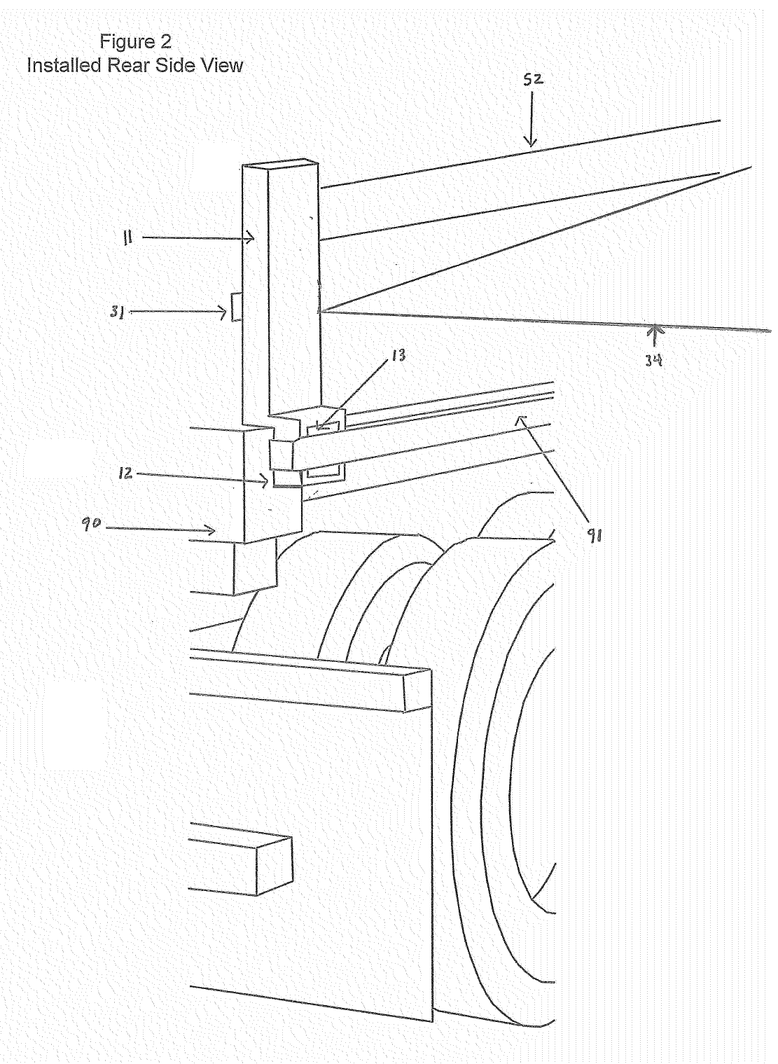

FIG. 2 Illustrates a Safety Warning Device in accordance with the present. The Safety Warning Device is secured to an extending leg (12) resting in a side rail (91) of the trailer (90) secured by the extending leg (12) resting in the side railing (91) of the trailer. The pad (13) on the extending leg removes any slack or looseness as the device needs to be unmoving. The post (11) is setting upright, also resting flat on the trailer floor. The extended arm (31) of the motion sensor mechanism is visible as is the sensor beam (34) as illustrated, not visible is the motion sensor mechanism (32) contained in the extended arm. The extendable visual tape (52) is shown in use, this hooks to the corresponding post (not shown), also not visible from this angle is the tape housing (51) and the connector hook (53) attached at the end of the visual tape. Also not shown is the alternative warning mechanism (61).

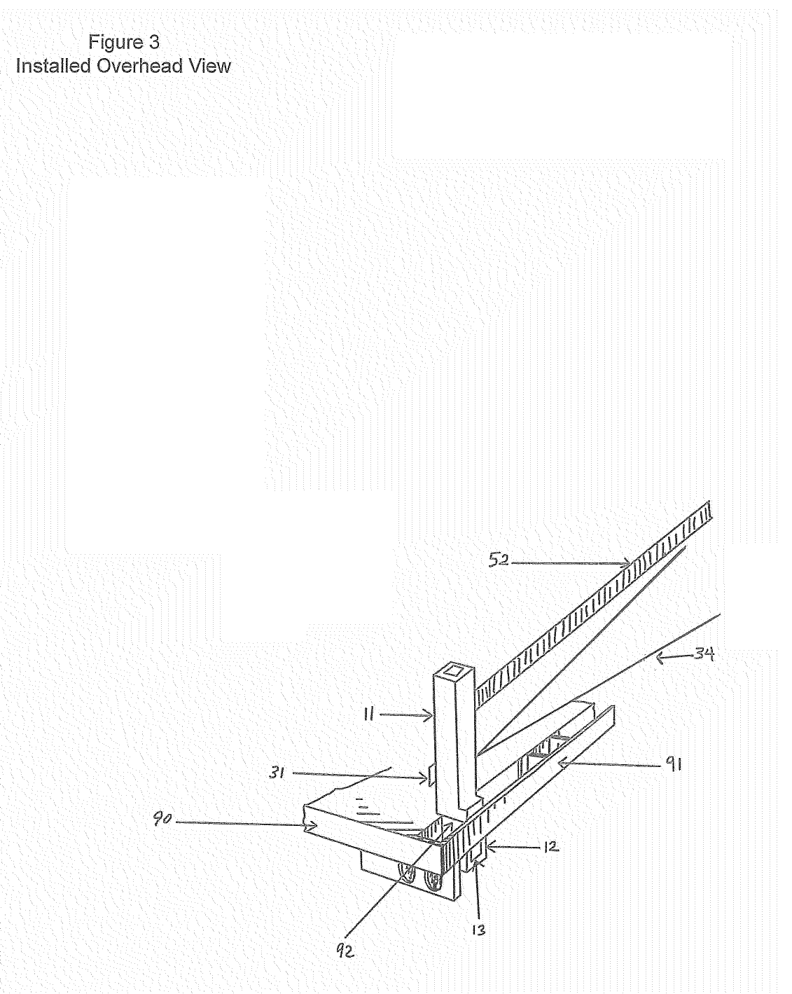

FIG. 3 Illustrates a Safety Warning Device in accordance with the present. The primary post (11) resting on the trailer (90) with the extending leg (12) nested in the trailer pocket (92) and side railing (91), being held secure by the pad (13) and adjustable mechanism for the pad (14) (which is not visible). The motion sensor is activated and the sensor beam (34) is illustrated, as well as the extended arm (31) of the motion sensor mechanism (32). The extendable visual tape (52) is shown; however neither the tape housing (51) nor the connector hook (53) is seen from this angle. Also not shown is the alternative warning mechanism (61).

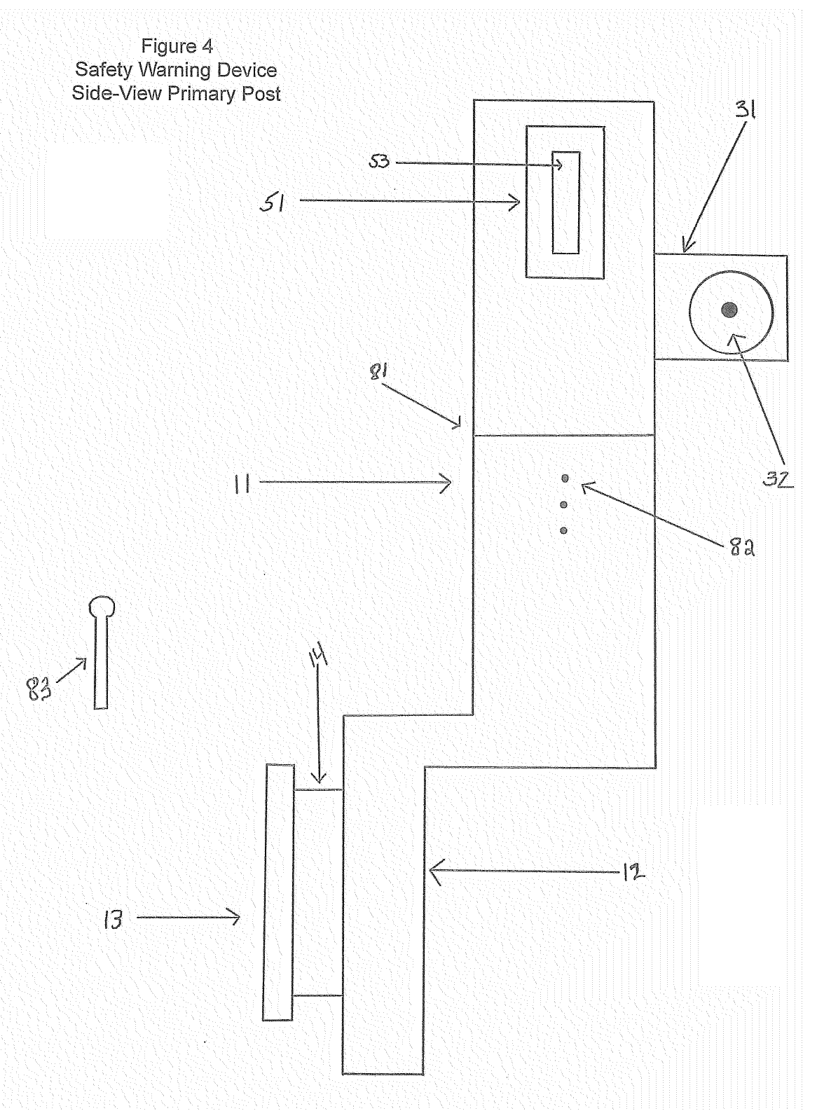

FIG. 4 Illustrates a Safety Warning Device in accordance with the present. A side view of the primary post (11), not engaged nor on a trailer. The extending leg (12) is shown from the side with the adjustable mechanism for the pad (14) and pad (13) fully visible. The extendable visual tape (52) is retractable in the tape housing (51) and not seen. The connector hook (53) is shown as it is attached to the end of the extendable visual tape. The extended arm (31) of the motion sensor is seen attached to the side of the post, which includes the motion sensor mechanism (32) which when activated beams the sensor beam (34) illustrated. Also not shown is the alternative warning mechanism (61). An optional height adjustment can be included in the posts shown as a height adjustment mechanism (81), a locking pin (83) which fits into a locking pin hole (82).

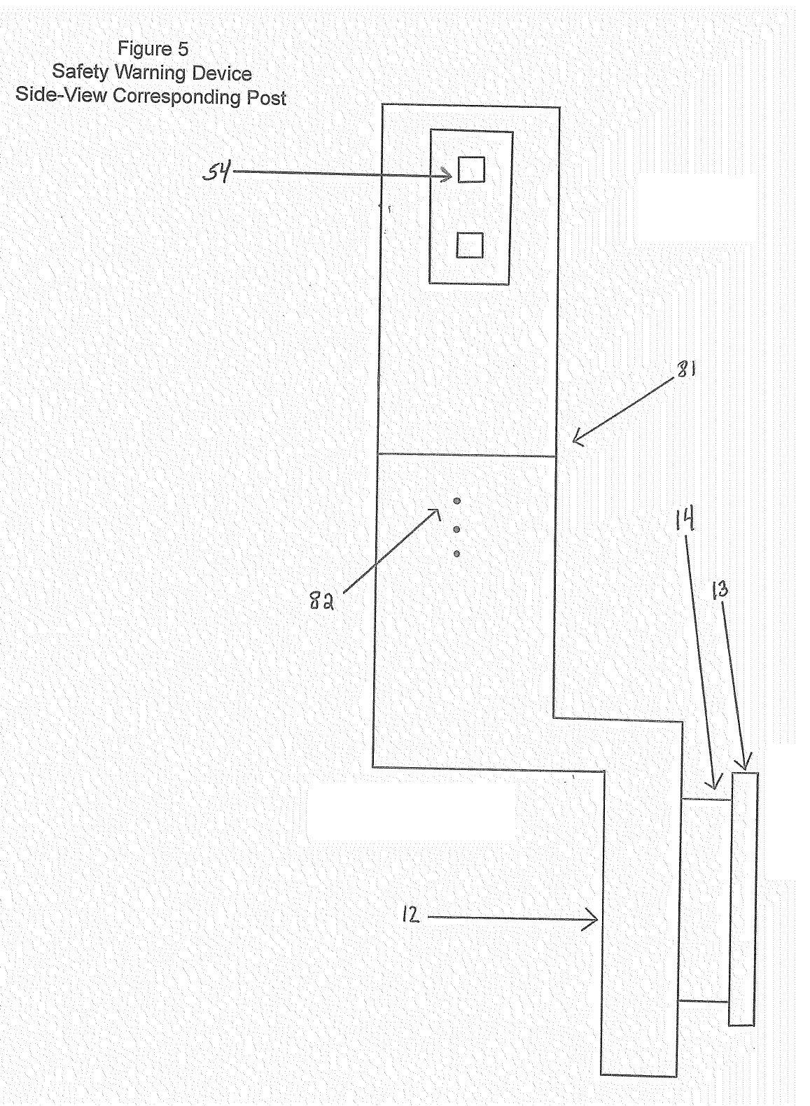

FIG. 5 Illustrates a Safety Warning Device in accordance with the present. A side view of the corresponding post (16) not engaged nor on a trailer. The extending leg (12) is shown from the side with the adjustable mechanism for the pad (14) and pad (13) fully visible. The extendable visual tape is not engaged, so the tape (51) and connector hook (53) is not seen. The connector hook would be secured in the connector housing (54) to lock into place, supporting the visual tape the length of the extension. Also not shown is the alternative warning mechanism (61). An optional height adjustment can be included in the posts shown as a height adjustment mechanism (81), a locking pin (not shown) which fits into a locking pin hole (82).

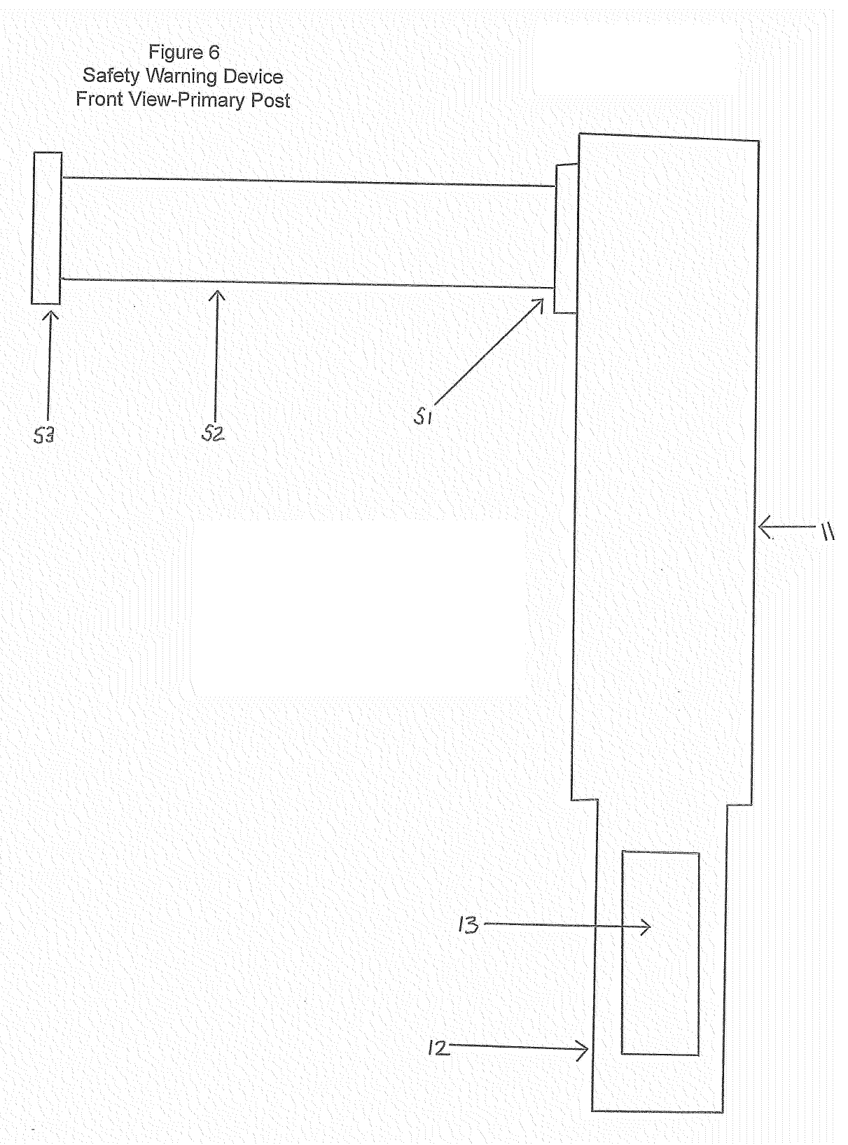

FIG. 6 Illustrates a Safety Warning Device in accordance with the present. A front view of the primary post (11), not fully engaged nor on a trailer, with the extended visual tape (52) extracted showing the connector hook (53) which is attached to the end of the visual tape. The tape housing (51) is viewable, which retracts or releases the tape. The extending leg (12) is shown with the pad (13) facing. Not in this view is the adjustable mechanism for the pad (14), hidden behind the pad. Also not seen is the extended arm (31), which houses the motion sensor mechanism. The motion sensor is not activated in this figure. Also not shown is the alternative warning mechanism (61).

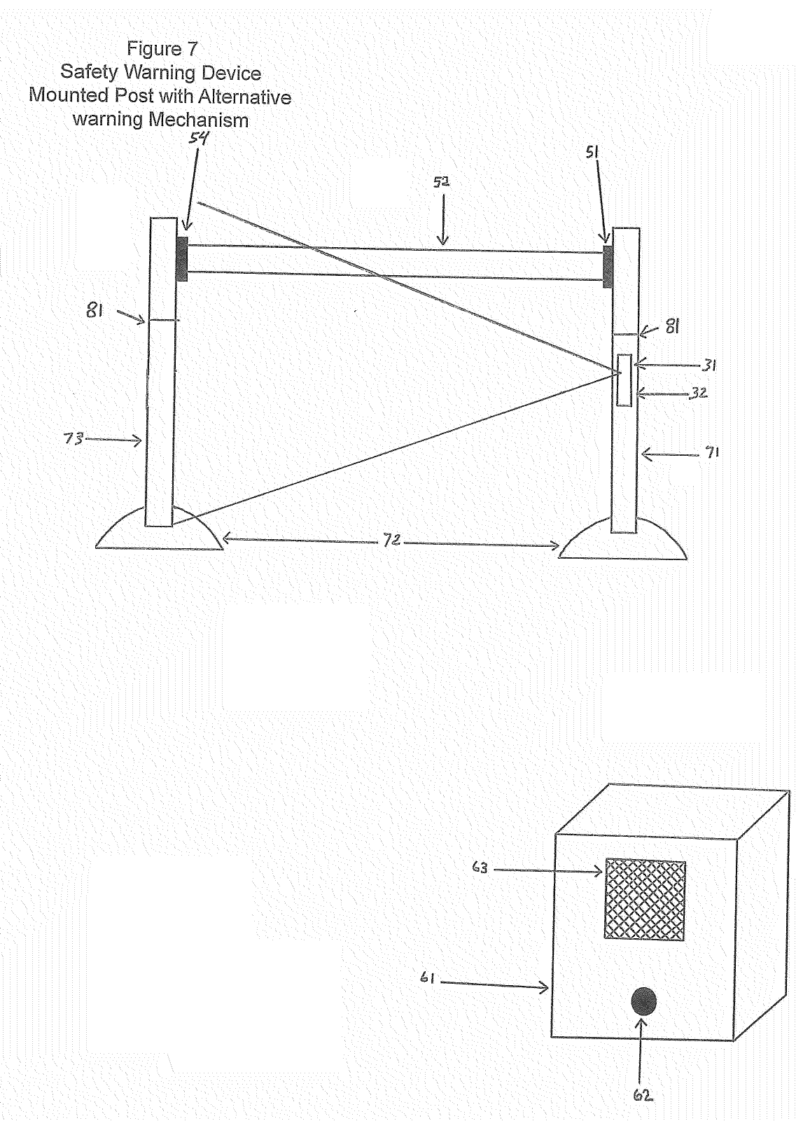

FIG. 7 Illustrates a Safety Warning Device in accordance with the present. A side view of the primary vertical post (71) and corresponding vertical post (73) installed in the mounting base (72) and fully engaged. The visual tape (52) is shown extended and hooked to the corresponding vertical post (16), there are limited views of the tape housing (51) and the connector housing (54). The connector hook (53) is not viewable because it is engaged in the connector housing. The sensor beam (34) is activated and visible, from this view and extended arm (31) and the motion sensor source mechanism (32). Also shown is an example of the alternative warning mechanism (61) which can warn off site personnel when the sensor beam is disturbed or interrupted. This warning can be visual from the visual light (62) or audibly from the audible alert mechanism (63). An optional height adjustment can be included in the posts shown as a height adjustment mechanism (81).

### OPERATION

A Safety Warning Device, which when in operation, a person places a primary (11) and corresponding post (16) on each side of a regular flatbed trailer. These posts are removable, convertible and storable. The posts are held in place by placing the extending leg (12) in either the trailer side railing (91) or trailer pocket (92). The post is further secured with the adjustable pad mechanism (14) and pad (13) which supplies tension pushing against the trailer rail.

An alternative mode of a Safety Warning Device whose visual and audible alerts are incorporated (extendable visual tape and motion sensor device) in a straight, primarily vertical (71) and corresponding vertical (73) post. These posts are held in place by a permanent base (72) and can be permanently secured or moveable (transportable).

The extendable visual tape (52) is pulled from the tape housing (51) which is contained in the primary post (or primary vertical post). The tape is extended and hooked to the connector housing (54) with the connector hook (53). The connector hook is attached to the extendable tape, the connector housing is contained in the corresponding post (or corresponding vertical post).

The motion sensor device is extended further away from the post by the extended arm (31) which houses the motion sensor source mechanism (32) in the primary post (primary vertical post). The motion sensor device can also alert an alternative warning mechanism (61) which is used to notify off site personnel.

When fully activated this Safety Warning Device alerts personnel (who may or may not be on loading machinery) by:

1. The extendable visual tape provides a visible warning of where the edge of the trailer is, or that the area is not authorized. The height of this tape makes it viewable to a person standing as well as someone using loading/unloading machinery.

2. The motion sensor provides a secondary audible warning with the sensor beam activating a warning signal. When this sensor beam is interrupted or disturbed a warning signal is sounded immediately warning that the edge of the trailer is near or that a person and/or object is in an unauthorized area. In addition a signal can be sent to the alternative warning mechanism notifying personnel not in the immediate area.

3. A Safety Warning Device using both the visual tape and the motion sensor, in conjunction provides a unique advantage. The extendable visual tape provides a clear visual warning and the motion sensor when activated provides an audible signal when the motion sensor is interrupted. This can be an immediate warning as well as a signal sent to the alternative warning mechanism notifying personnel not in the immediate area.

4. A Safety Warning Device with an alternative warning mechanism, which alerts off site personnel when the sensor beam is disturbed or interrupted. This allows for people not in the immediate area to provide assistance, aid or increased supervision when notified of this breach in security.

1. A Safety Warning Device comprising
a primary and corresponding post formed to rest on the bed of a flatbed trailer; said posts include an adjustable pad, which is a means for securing the post to the trailer
a visual tape able to be secured between the primary and corresponding post
a motion sensor secured to the primary post, wherein the sensor source emits a beam detecting motion or entry into a dangerous or restricted area.

2. The Safety Warning Device of claim 1 wherein the visual tape is a means for visual warning to the proximity of the trailer edge.

3. The Safety Warning Device of claim 1 further including an audible indication when an associated object interrupts said sensor beam emitted by the motion sensor source.

4. The Safety Warning Device of claim 3 further including an alternative warning mechanism, wherein when the sensor beam is interrupted an electronic signal is sent to said alternative warning mechanism producing an audible, visual, or both audible and visual warning.

5. The Safety Warning Device of claim 1 further including a means for adjusting the height of said primary and corresponding posts.

6. The Safety Warning Device of claim 1 further including said primary and corresponding posts wherein the posts are portable and storable.

7. A Safety Warning Device comprising
a primary and corresponding vertical post mounted to a base, whose base is not permanently secured to flooring or a platform allowing for portability
a visual tape able to be secured between the primary and corresponding post
a motion sensor source secured to the primary post, wherein the motion sensor source emits a sensor beam

8. The Safety Warning Device of claim 7 wherein the visual tape is a means for visual warning a person of impending danger.

9. The Safety Warning Device of claim 7 further including an audible indication when an associated object interrupts said sensor beam emitted by the motion sensor source.

10. The Safety Warning Device of claim 9 further including an alternative warning mechanism, wherein when the sensor beam is interrupted, a signal is sent to said alternative warning mechanism producing an audible, visual or both audible and visual warning.

11. The Safety Warning Device of claim 7 further including a means for adjusting the height of said primary and corresponding posts.

12. The Safety Warning Device of claim 7 wherein said base is permanently secured, whereby the Safety Warning Device is stationary.

13. A safety warning device comprising
a primary and corresponding vertical post mounted to a base, whose base is not permanently secured allowing for portability
a visual tape able to be secured between the primary and corresponding post
a motion sensor source secured to the primary post, wherein the motion sensor source emits a sensor beam

14. The Safety Warning Device of claim 13 wherein the visual tape is a means for visually warning a person of impending danger.

15. The Safety Warning Device of claim 13 further including an audible indication when an associated object interrupts said sensor beam emitted by the motion sensor source.

16. The Safety Warning Device of claim 7 further including a means for adjusting the height of said primary and corresponding posts.

17. The Safety Warning Device of claim 13 wherein said base is permanently secured, whereby the Safety Warning Device is stationary.
